(19) United States
(12) Patent Application Publication
(10) Pub. No.: US 2014/0246990 A1
(43) Pub. Date: Sep. 4, 2014

(54) LIGHTING DEVICE AND LIGHTING CONTROL METHOD

(71) Applicants: Young Jin Kim, Seoul (KR); Jong Chan Park, Seoul (KR); Ki Soo Kwon, Seoul (KR); Seung Beom Jeong, Seoul (KR); Eon Ho Son, Seoul (KR)

(72) Inventors: Young Jin Kim, Seoul (KR); Jong Chan Park, Seoul (KR); Ki Soo Kwon, Seoul (KR); Seung Beom Jeong, Seoul (KR); Eon Ho Son, Seoul (KR)

(73) Assignee: LG Inntotek Co., Ltd., Seoul (KR)

(21) Appl. No.: 13/809,535

(22) PCT Filed: Sep. 7, 2012
(86) PCT No.: PCT/KR12/07223

§ 371 Date: May 21, 2014

(30) Foreign Application Priority Data
Sep. 8, 2011 (KR) 10-2011-0091147
Sep. 8, 2011 (KR) 10-2011-0091148
Dec. 6, 2011 (KR) 10-2011-0129351

(51) Int. Cl. H05B 33/08

(52) U.S. Cl. CPC H05B 33/0857
USPC 315/250; 315/227 R

(57) ABSTRACT

A lighting device may be provided that includes: a first to a fourth light emitting devices which are disposed on a substrate a first and a second pulse width modulation controllers which perform a pulse width modulation on currents applied to the first and the second light emitting devices respectively; and a first and a second controllers which control respectively currents applied to the third and the fourth light emitting devices having color temperatures different from those of the first and the second light emitting devices, wherein an (x, y) coordinate, which is determined by the mixture of the lights emitted from the first to the fourth light emitting devices and is located within a 1931 CIE chromaticity diagram, is moved onto a black body radiation curve within the 1931 CIE chromaticity diagram through the pulse width modulation of the first and the second pulse width modulation controllers and the control of the first and the second controllers.

### TECHNICAL FIELD

This embodiment relates to a lighting device and a lighting control method.

### BACKGROUND ART

A white light emitting device is now increasingly used in, for example, an LCD backlight unit, a camera phone flash, an electric sign, a lighting device and the like. Therefore, many researches are now being actively devoted to the white light emitting device.

A method for manufacturing the white light emitting device includes a method using a single chip and a method using multi-chips. The method using a single chip is to obtain white light by adding a phosphor on a blue LED chip or an UV LED chip. The method using multi-chips is to obtain white light by combining two or three LED chips emitting lights having mutually different wavelengths.

One of the methods using multi-chips is to create white light by combining three R, G and B LED chips. However, an operating voltage of each of the LED chips is not uniform and the output of each of the LED chips is changed according to an ambient temperature, so that the color coordinate of the LED chip is changed. Therefore, generally, the white light emitting device is easily and efficiently manufactured by the method using a single chip. For example, a white LED is manufactured by combining a blue LED and a phosphor which is excited by the blue LED and emits yellow light. Also, the white light is created by mixing UV LED light and light which has multiple wavelengths and is excited by the UV LED. Here, UV light is wholly used to excite the phosphor and does not contribute directly to the generation of the white light.

Meanwhile, an indicator for analyzing the characteristic of white light includes a correlated color temperature (CCT) and a color rendering index (CRI). Regarding an object emits visible light and shines, when the color of the object is the same as a color that a certain temperature black body radiates, the temperature of the black body and the temperature of the object are considered to be the same as each other. Here, the CCT represents the temperature. Since the color of white light having a low color temperature seems to be warmer and the color of white light having a high color temperature seems to be colder, it is possible to create various color senses by controlling the color temperature.

When sunlight is irradiated to an object and artificial lighting is irradiated, the color of the object is changed. Here, the CRI represents how much the color of the object is changed. When the color of the object is the same as the color under sunlight, the CRI is defined to be 100. That is, the CRI represents how similar the color of the object under the artificial lighting is to the color of the object under sunlight. The CRI has values from 0 to 100. The closer the CRI of a white light source is to 100, the light from the white light source seems to be more similar to sunlight. While the CRI of an incandescent bulb is greater than 80 and the CRI of a fluorescent lamp is greater than 75, the CRI of a commercially used white LED is approximately 70 to 75.

Therefore, there is a requirement that white light should be seem to be similar to natural light by improving color rendering property.

### DISCLOSURE OF INVENTION

### Technical Problem

The objective of the present invention is to provide a lighting device and a lighting control method which cause the color coordinate of light emitted a white light emitting device to be located on a black body radiation curve within a 1931 CIE chromaticity diagram, and then provide white light similar to natural light. As a result, optical efficiency and color rendering property can be more improved.

### Solution to Problem

One embodiment is a lighting device. The lighting device includes: a first to a fourth light emitting devices which are disposed on a substrate a first and a second pulse width modulation controllers which perform a pulse width modulation on currents applied to the first and the second light emitting devices respectively; and a first and a second controllers which control respectively currents applied to the third and the fourth light emitting devices having color temperatures different from those of the first and the second light emitting devices. An (x, y) coordinate, which is determined by the mixture of the lights emitted from the first to the fourth light emitting devices and is located within a 1931 CIE chromaticity diagram, is moved onto a black body radiation curve within the 1931 CIE chromaticity diagram through the pulse width modulation of the first and the second pulse width modulation controllers and the control of the first and the second controllers.

The first light emitting device, the second light emitting device, the third light emitting device and the fourth light emitting devices are disposed in the form of a linear array in the order listed.

Color temperatures of the first and the third light emitting devices are higher than those of the second and the fourth light emitting devices.

The lighting device further includes a mixing chamber which receives the first to the fourth light emitting devices and has an open upper portion; and an optical excitation plate which is disposed on the mixing chamber and is spaced apart from the first to the fourth light emitting devices.

A distance between the optical excitation plate and the first to the fourth light emitting devices is determined by an optical orientation angle of each of the light emitting devices and a distance between the light emitting devices.

When a distance between the first to the fourth light emitting devices and the optical excitation plate is “H” and the optical orientation angle of each of the light emitting devices is “θ”, the distance G between the light emitting devices is calculated by an equation of G=2H tan(θ/2).

A distance “L” between an inner wall of the mixing chamber and a light emitting device located at the outermost among the first to the fourth light emitting devices is calculated by an equation of L≧G/2.

When a plurality of the light emitting devices are symmetrically disposed, the distance “G” between the light emitting devices is minimized.

The distance “H” between the first to the fourth light emitting devices and the optical excitation plate is determined within a range in which lights generated from each of the light emitting devices are not superposed on each other or are superposed on each other by less than 10%.

The distance “G” between the light emitting devices is between 25 mm and 30 mm.

Both inner walls of the mixing chamber are equally vertical or equally inclined.

The lighting device further includes a reflector which is disposed to have the same inclined surfaces on both inner walls of the mixing chamber.

The lighting device further includes a lens unit which is disposed on the optical excitation plate and adjusts an orientation angle of the light.

The lens unit has any one of a concave shape, a convex shape and a hemispherical shape and is formed of any one of an epoxy resin, a silicone resin, a urethane resin or a compound of them.

Another embodiment is a lighting device. The lighting device includes: a first white light emitting device which includes a first light emitting chip disposed on a substrate and a first phosphor converting first light emitted from the first light emitting chip; a second white light emitting device which includes a second light emitting chip disposed on the substrate and a second phosphor converting second light emitted from the second light emitting chip; and a red light emitting device which is disposed on the substrate and emits red light. An (x, y) coordinate, which is determined by the mixture of the lights emitted from the first and the second white light emitting devices and the red light emitting device and is located within a 1931 CIE chromaticity diagram, is moved onto a black body radiation curve within the 1931 CIE chromaticity diagram by wavelength deviations of 1 nm to 70 nm of the first and the second lights.

Further another embodiment is a lighting device. The lighting device includes: a light source which includes a first light emitting device emitting first light, a second light emitting device emitting second light, and a red light emitting device emitting red light, wherein the first light emitting device, the second light emitting device and the red light emitting device are disposed on a substrate; and an optical excitation plate which is disposed on the light source and is disposed apart at a predetermined interval from the first light emitting device, the second light emitting device and the red light emitting device, and includes a yellow phosphor. An (x, y) coordinate, which is determined by the mixture of the lights emitted from the first and the second light emitting devices and the red light emitting device and is located within a 1931 CIE chromaticity diagram, is moved onto a black body radiation curve within the 1931 CIE chromaticity diagram by wavelength deviations of 1 nm to 70 nm of the first and the second lights.

The first and the second lights have a wavelength of from 420 nm to 490 nm.

The larger the deviations of the wavelengths of the first and the second lights become, the smaller the magnitudes of currents applied to the first and the second white light emitting devices, so that a color of the emitted light is changed.

The larger the deviations of the wavelengths of the first and the second lights become, the smaller the magnitudes of currents applied to the first and the second light emitting devices, so that a color of the emitted light is changed.

The substrate includes a first substrate and a second substrate disposed apart from the first substrate. The first white light emitting device is disposed on the first substrate. The second white light emitting device is disposed on the second substrate. The phosphor is a garnet (including YAG) phosphor or an oxynitride phosphor

A distance between the optical excitation plate and each of the light emitting devices of the light source is determined by an optical orientation angle of each of the light emitting devices and a distance between the light emitting devices.

When a distance between the first and the second light emitting devices and the red light emitting device and the optical excitation plate is “H” and the optical orientation angle of each of the light emitting devices is “θ”, the distance G between the light emitting devices is calculated by an equation of G=2H tan(θ/2).

The lighting device further includes a mixing chamber which receives the light source and has an open upper portion.

A distance “L” between an inner wall of the mixing chamber and a light emitting device located at the outermost among the light emitting devices of the light source is calculated by an equation of L≧G/2.

When a plurality of the light emitting devices are symmetrically disposed, the distance “G” between the light emitting devices is minimized.

The distance “H” between each of the light emitting devices of the light source and the optical excitation plate is determined within a range in which lights generated from each of the light emitting devices are not superposed on each other or are superposed on each other by less than 10%.

The distance “G” between the light emitting devices is between 25 mm and 30 mm.

Both inner walls of the mixing chamber are equally vertical or equally inclined.

The lighting device further includes a reflector which is disposed to have the same inclined surfaces on both inner walls of the mixing chamber.

The lighting device further includes a lens unit which is disposed on the optical excitation plate and adjusts an orientation angle of the light.

The lens unit has any one of a concave shape, a convex shape and a hemispherical shape and is formed of any one of an epoxy resin, a silicone resin, a urethane resin or a compound of them.

Yet another embodiment is a lighting control method. The method includes: a first step of applying first set current and second set current to a first and a second light emitting devices respectively, and of obtaining a (x, y) coordinate which is determined by the mixture of the lights emitted from the first and the second light emitting devices and is located within a 1931 CIE chromaticity diagram a second step of respectively applying third set current and fourth set current to a third and a fourth light emitting devices having color temperatures different from those of the first and the second light emitting devices, and of obtaining a (x, y) coordinate which is determined by the mixture of the lights emitted from the first to the fourth light emitting devices and is located within the 1931 CIE chromaticity diagram and a third step of pulse-width modulating the current applied to at least one of the first and the second light emitting devices, of controlling the current applied to at least one of the third and the fourth light emitting devices, and of moving the (x, y) coordinate determined by the mixture of the lights emitted from the first to the fourth light emitting devices onto a black body radiation curve within the 1931 CIE chromaticity diagram.

In the third step, the currents applied to the first to the fourth light emitting devices are independently controlled.

In the third step, an x value and a y value of the (x, y) coordinate become smaller with the decrease of a pulse-width of the current applied to the first light emitting device or the second light emitting device.

Still another embodiment is a lighting control method. The method includes: a first step of applying first set current to a first light emitting device, and of obtaining a (x, y) coordinate which is determined by light emitted from the first light emitting device and is located within a 1931 CIE chromaticity diagram a second step of applying second set current to a red light emitting device, and of obtaining a (x, y) coordinate which is determined by the mixture of the lights emitted from the first light emitting device and the red light emitting device; a third step of applying third set current to a second light emitting device, and of obtaining a (x, y) coordinate which is determined by the mixture of the lights emitted from the first light emitting device, the red light emitting device and the second light emitting device; and a fourth step of controlling the current applied to at least one of the first light emitting device, the second light emitting device and the red light emitting device, and of moving the (x, y) coordinate determined by the mixture of the lights emitted from the first light emitting device, the red light emitting device and the second light emitting device onto a black body radiation curve within the 1931 CIE chromaticity diagram.

The first light emitting device and the second light emitting device use a light emitting chip emitting blue light and light excited by phosphor emitting light having a wavelength different from that of the blue light in response to the blue light, so that the color coordinate is obtained.

In the fourth step, the current applied to at least one of the first light emitting device, the second light emitting device and the red light emitting device is controlled, and then the (x, y) coordinate moves along the black body radiation curve in a direction in which the value of x is reduced.

The first light emitting device and the second light emitting device are a white light emitting device.

In the fourth step, the currents applied to the first light emitting device, the red light emitting device and the second light emitting device are independently controlled.

### Advantageous Effects of Invention

A lighting device and a lighting control method according to the embodiment cause the color coordinate of light emitted a white light emitting device to be located on a black body radiation curve within a 1931 CIE chromaticity diagram, and then provide white light similar to natural light. As a result, optical efficiency and color rendering property can be more improved.

### BRIEF DESCRIPTION OF DRAWINGS

FIG. 1 is a view schematically showing a lighting device according to a first embodiment;

FIG. 2 is a cross sectional view showing a lighting design under an optimum condition by means of a light emitting device and an optical excitation plate of FIG. 1

FIG. 3 is a cross sectional view showing that a reflector are disposed on both inner walls a mixing chamber of FIG. 2;

FIG. 4 is a cross sectional view showing that a lens unit is disposed on the optical excitation plate of FIG. 2;

FIG. 5 is a mimetic diagram for describing a method of calculating a distance between the light emitting devices of FIGS. 2 to 4;

FIG. 6 is a view showing a distance between the inner wall of the mixing chamber and the light emitting device located at the outermost of FIGS. 2 to 4;

FIG. 7 is a graph showing a luminous flux change according to the distance between the light emitting devices of FIGS. 2 to 4;

FIG. 8 is a graph showing a current magnitude by pulse width modulation according to the first embodiment;

FIG. 9 is a graph showing a color coordinate change by the pulse width modulation of FIG. 8;

FIG. 10 is a view for describing a lighting control method on a black body radiation curve according to the first embodiment;

FIG. 11 is a view showing a principle in which a color coordinate is obtained on the black body radiation curve according to the first embodiment;

FIG. 12 is a schematic view of a lighting device according to a second embodiment;

FIG. 13 is a schematic view of the lighting device including two light sources according to the second embodiment;

FIG. 14 is a schematic view of the lighting device including an optical excitation plate according to the second embodiment;

FIG. 15 is a view showing a principle in which a color coordinate is obtained on the black body radiation curve according to the second embodiment.

### MODE FOR THE INVENTION

Hereafter, a thickness or size of each layer is magnified, omitted or schematically shown for the purpose of convenience and clearness of description. The size of each component does not necessarily mean its actual size.

In description of embodiments of the present invention, when it is mentioned that an element is formed “on” or “under” another element, it means that the mention includes a case where two elements are formed directly contacting with each other or are formed such that at least one separate element is interposed between the two elements. The “on” and “under” will be described to include the upward and downward directions based on one element.

### First Embodiment

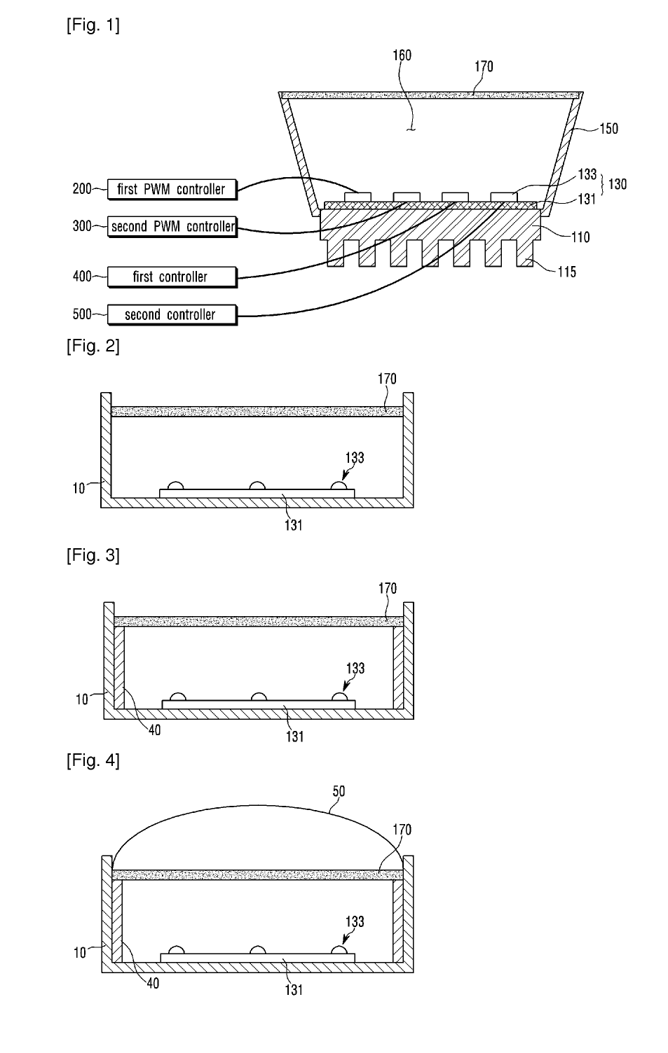

FIG. 1 is a view schematically showing a lighting device according to a first embodiment.

Referring to FIG. 1, the lighting device according to the first embodiment may include a heat sink 110, a light source 130, a reflector 150, an optical excitation plate 170, a first pulse width modulation (PWM) controller 200, a second pulse width modulation (PWM) controller 300, a first controller 400 and a second controller 500.

First, amixing chamber (without a reference numeral) is formed by the reflector 150 and the heat sink 110. The mixing chamber receives the light source 130. A mixing space 160 may be formed within the mixing chamber. The optical excitation plate 170 is disposed on the upper portion of the open mixing chamber. Here, the lights which are emitted from the light source 130 or the lights which are emitted from the light source 130 and are reflected by the reflector 150 are mixed in the mixing space 160.

The heat sink 110 may receive heat from the light source 130 and radiate the heat. The heat sink 110 has one surface on which the light source 130 is disposed. Here, the surface on which the light source 130 is disposed may be flat or may have a predetermined curvature.

Also, the heat sink 110 may have a heat radiating fin 115. The heat radiating fin 115 may project or extend outwardly from one side of the heat sink 110. The heat radiating fin 115 increases the heat radiating area of the heat sink 110. Therefore, heat radiation efficiency of the lighting device may be improved by the heat radiating fin 115.

Also, the heat sink 110 may be formed of a metallic material or a resin material, each of which has excellent heat radiation efficiency. However, there is no limit to the material of the heat sink 110. For example, the material of the heat sink 110 may include at least one of Al, Ni, Cu, Ag and Sn.

The light source 130 is disposed on the heat sink 110 and emits predetermined light above the heat sink 110. The light source 130 may include a substrate 131 and a light emitting device 133.

The substrate 131 may be one of a common PCB, a metal core PCB (MCPCB), a standard FR-4 PCB or a flexible PCB. The substrate 131 may directly contact with the heat sink 110. The substrate 131 may be disposed on one side of the heat sink 110.

Also, at least one light emitting device 133 is disposed on the substrate 131. A light reflective material may be coated or deposited on the substrate 131 in order to easily reflect the light from the light emitting device 133.

For structural purpose or so as to enhance the heat transfer to the heat sink 110, the substrate 131 may selectively include a thermally conductive adhesive tape or a thermal pad.

A plurality of the light emitting devices 133 may be disposed on the substrate 131. The plurality of the light emitting devices 133 may emit light having the same wavelength or lights having mutually different wavelengths. The plurality of the light emitting devices 133 may emit light having the same color or lights having mutually different colors.

Also, the light emitting device 133 may be one of a blue light emitting device emitting blue light, a green light emitting device emitting green light, a red light emitting device emitting red light, a white light emitting device emitting white light.

The light emitting device 133 may include a light emitting diode (LED) chip. The LED chip may be one of a blue LED chip emitting blue light in a visible light spectrum, a green LED chip emitting green light, and a red LED chip emitting red light. Here, the blue LED chip has a dominant wavelength of from about 430 nm to 480 nm. The green LED chip has a dominant wavelength of from about 510 nm to 535 nm. The red LED chip has a dominant wavelength of from about 600 nm to 630 nm.

Here, a lighting design under an optimum condition by means of the light emitting device 133 and the optical excitation plate 170 will be described below.

First, the mixing chamber will be omitted or schematically shown in FIGS. 2 to 4 for the sake of convenience and clarity of the following description,

### Embodiment of a Lighting Design Under an Optimum Condition by Means of the Light Emitting Device and the Optical Excitation Plate

FIG. 2 is a cross sectional view showing a lighting design under an optimum condition by means of the light emitting device and the optical excitation plate of FIG. 1.

Referring to FIG. 2, for the purpose of a lighting design under the optimum condition, in a state where the height of the light emitting device 133 is fixed, the disposition interval of the light emitting devices 133, which maximizes luminous efficiency, may be determined by using the optical orientation angle of the light emitting device 133 and a distance between the light emitting device 133 and the optical excitation plate 170.

FIG. 3 is a cross sectional view showing that a reflector are disposed on both inner walls a mixing chamber of FIG. 2.

Referring to FIG. 3, in the lighting device according to the first embodiment, a reflector 40 having the same inclined surface may be further disposed on both inner walls of a mixing chamber 10. Here, the reflector 40 is disposed to totally reflect the light emitted from the light emitting device 133. The reflector 40 may be formed vertically or formed inclined to some degree.

FIG. 4 is a cross sectional view showing that a lens unit is disposed on the optical excitation plate of FIG. 2.

Referring to FIG. 4, the lighting device according to the first embodiment may be configured by forming a lens unit 50 on the optical excitation plate 170.

Here, the lens unit 50 may be formed with a lens so as to increase the orientation angle of the light emitted from the light emitting device 133. Through this, the lens unit 50 is able to improve the uniformity of a linear light source of the lighting device according to the first embodiment.

The lens unit 50 may have any one of a concave shape, a convex shape and a hemispherical shape. The lens unit 50 may be formed of an epoxy resin, a silicone resin, a urethane resin or a compound of them.

### Embodiment of a Method for Designing the Lighting Device

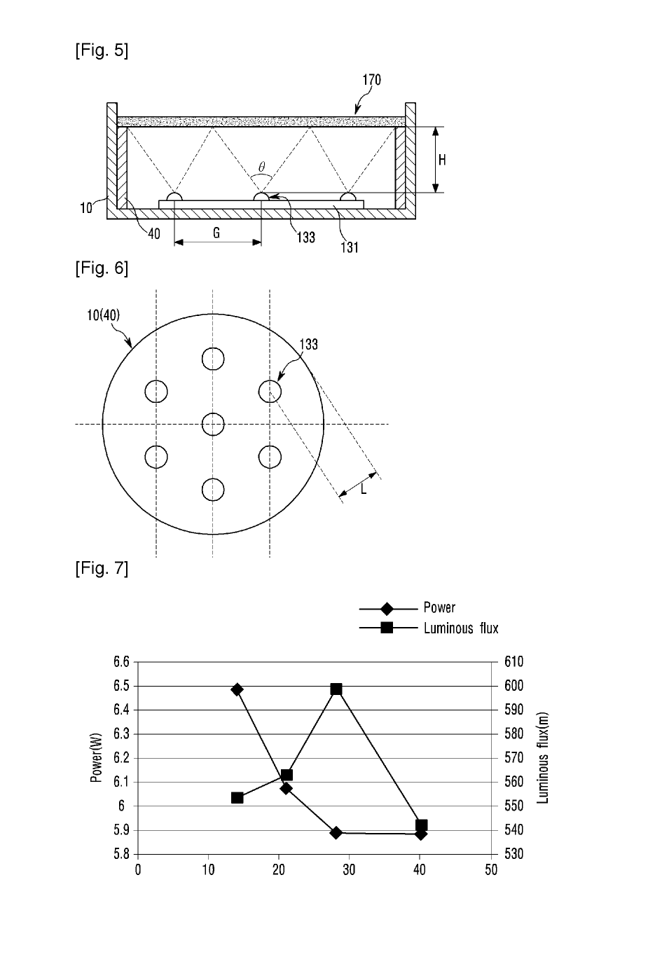

FIG. 5 is a mimetic diagram for describing a method of calculating a distance between the light emitting devices of FIGS. 2 to 4. FIG. 6 is a view showing a distance between the inner wall of the mixing chamber and the light emitting device located at the outermost of FIGS. 2 to 4.

First, the light emitting device 133 may be comprised of a single or a plurality of blue LEDs having a wavelength of 430 nm to 480 nm. The optical excitation plate 170 may be comprised of a single or a plurality of yellow phosphors and a single or a plurality of green phosphors. Here, when the light emitting device 133 has an optical orientation angle of 100° to 120° and the optical excitation plate 170 is comprised of a single or a plurality of yellow phosphors and a single or a plurality of green phosphors, light which passes through the optical excitation plate 170 and is emitted may have a wavelength of 510 nm to 585 nm.

Referring to FIG. 5, assuming that a distance between the light emitting device 133 and the optical excitation plate 170 is denoted by “H” and the optical orientation angle of the light emitting device 133 is denoted by “θ”, a distance “G” between the light emitting devices 133 can be represented by the following equation (1).

G=2H tan(θ/2) equation (1)

Here, it is recommended that the distance “H” between the light emitting device 133 and the optical excitation plate 170 should be determined within a range in which the lights generated from the light emitting device 133 is not superposed on each other. However, there may be an error range of less than 10% depending on the number of the light emitting devices 133.

In addition, when the plurality of the light emitting devices 133 are symmetrically disposed, the distance “G” between the light emitting devices 133 is minimized.

Preferably, the distance “G” between the light emitting devices 133 is between 25 mm and 30 mm.

As shown in equation (1), it can be seen that the distance “H” between the light emitting device 133 and the optical excitation plate 170 is determined by the distance “G” between the light emitting devices 133 and the optical orientation angle “θ” of the light emitting device 133. Therefore, when the distance “G” between the light emitting devices 133 and the optical orientation angle “θ” of the light emitting device 133 are known, the distance “H” between the light emitting device 133 and the optical excitation plate 170 can be obtained by the equation (1).

Moreover, when the distance between the light emitting device 133 and the optical excitation plate 170 and the optical orientation angle of the light emitting device 133 are known, the distance between the light emitting devices 133 can be also obtained.

Next, referring to FIG. 6, a distance “L” between the inner wall of the mixing chamber 10 and a light emitting device located at the outermost among the light emitting devices 133 can be represented by the following equation (2).

L≧G/2 equation (2)

As shown in equation (2), the distance “L” between the inner wall of the mixing chamber 10 and the light emitting device 133 located at the outermost may be formed to be larger than a half of the distance “G” between the light emitting devices 133.

### Simulation Example

FIG. 7 is a graph showing a luminous flux change according to the distance between the light emitting devices of FIGS. 2 to 4.

First, when six light emitting devices 133 are, as shown in FIG. 6, disposed symmetrically with respect to the center, there is an experiment in which a luminous flux is changed while the disposition area of the light emitting devices 133 is changed from 14 mm×14 mm to 40 mm×40 mm.

The graph of FIG. 7 shows the result of the experiment. The result shows that the more widely the light emitting devices 133 are distributed (that is, the larger the distance between the light emitting devices 133), the more the luminous flux is increased and then is decreased when the disposition area is greater than a certain area (for example, 27 mm×27 mm to 29 mm×29 mm).

In the simulation result, the maximum luminous flux is obtained when the disposition area of the light emitting devices 133 is within a range of 27 mm×27 mm to 29 mm×29 mm.

As shown in the simulation result, it can be found that the luminous flux becomes different in accordance with the distance between the light emitting devices 133 and there exists an optimum distance between the light emitting devices.

As described in FIGS. 2 to 7, it is possible to obtain the distance between the light emitting devices 133, which maximizes luminous efficiency, by using the optical orientation angle of the light emitting device 133 and the distance between the light emitting device 133 and the optical excitation plate 170.

Also, the distance between the light emitting devices 133, which maximizes luminous efficiency, is represented by a relational expression, thereby obtaining a lighting design under the optimum condition.

Moreover, it is also possible to obtain the distance between the light emitting device 133 and the optical excitation plate 170, which maximizes luminous efficiency, only by means of the distance between the light emitting devices 133 and the optical orientation angle of the light emitting device 133.

Moreover, in a state where the height of the light emitting device 133 is fixed, it is also possible to obtain a distance between the light emitting devices 133, which maximizes luminous efficiency, only by means of the distance between the light emitting device 133 and the optical excitation plate 170 and the optical orientation angle of the light emitting device 133.

Moreover, it is also possible to overcome luminous efficiency degradation caused by the disposition of the light emitting devices 133 and errors caused by color coordinate deviation. Accordingly, the reliability of a product can be remarkably enhanced.

Moreover, even in a case of mass production, luminous efficiency becomes higher and a desired color coordinate can be obtained.

Moreover, in a state where the light emitting devices are disposed in such a manner as to obtain the optimum luminous efficiency, the lens unit 50 is further disposed on the optical excitation plate 170, so that it is possible to satisfy both of the luminous efficiency and color coordinate and to control the orientation angle of the light.

Further, Referring to FIG. 1, the light emitting device 133 may further include a phosphor. The phosphor may be mixed with a solvent of resin and cover the LED chip. The phosphor may be at least one of a yellow phosphor, a green phosphor and a red phosphor.

The yellow phosphor may emit yellow light having a dominant wavelength of from 540 nm to 585 nm in response to blue light (430 nm to 480 nm) from the blue LEDchip. The green phosphor may emit green light having a dominant wavelength of from 510 nm to 535 nm in response to the blue light (430 nm to 480 nm). The red phosphor may emit red light having a dominant wavelength of from 600 nm to 650 nm in response to the blue light (430 nm to 480 nm).

The yellow phosphor may be a silicate phosphor, a YAG of a garnet phosphor and an oxynitride phosphor. The yellow phosphor may emit light having a dominant wavelength of from 555 nm to 585 nm in response to the blue light. The yellow phosphor may be selected from Y3Al5O12:Ce3+(Ce:YAG), CaAlSiN3:Ce3+ and Eu2+—SiAlON phosphor and/or may be selected from BOSE phosphor. The yellow phosphor may be doped at an arbitrary appropriate level so as to provide light output of a desired wavelength. Ce and/or Eu may be doped in the phosphor at a dopant concentration of about 0.1% to about 20%. A phosphor appropriate for this purpose may include products produced by Mitsubishi Chemical Company (Tokyo, Japan), Leucht-stoffwerk Breitungen GmbH (Breitungen, Germany) and Intermatix Company (Fremont, Calif.).

The green phosphor may be a silicate phosphor, a nitride phosphor and an oxynitride phosphor. The green phosphor may emit light having a dominant wavelength of from 510 nm to 535 nm in response to the blue light.

The red phosphor may be a nitride phosphor and a sulfide phosphor. The red phosphor may emit light having a dominant wavelength of from 600 nm to 650 nm in response to the blue light. The red phosphor may include CaAlSiN3:Eu2+ and Sr2Si5N8:Eu2+. These phosphors are able to cause a quantum efficiency to be maintained greater than 80% at a temperature higher than 150° C. Another usable red phosphor may be selected from not only CaSiN2:Ce3+ and CaSiN2:Eu2+ but Eu2+—SiAlON phosphor and/or may be selected from (Ca,Si,Ba)SiO4:Eu2+(BOSE) phosphor. Particularly, a CaAlSiN:Eu2+ phosphor of the Mitsubishi Chemical Company may have a dominant wavelength of about 624 nm, a peak wavelength of about 628 nm and FWHM of about 100 nm.

The plurality of the light emitting devices 133 may be comprised by combining the blue light emitting devices and the red light emitting devices or by combining the blue light emitting devices, the red light emitting devices and the green light emitting devices or may be comprised of only the white light emitting devices.

The reflector 150 reflects the light emitted from the light source 130. The reflector 150 surrounds the light source 130. The reflector 150 is able to easily reflect outwardly the light emitted from the light source 130.

The reflector 150 may include a reflective surface which reflects the light emitted from the light source 130. The reflective surface may substantially form a right angle with the substrate 131 or may substantially form an obtuse angle with the top surface of the substrate 131. The reflective surface may be coated or deposited with a material capable of easily reflecting the light.

In the first embodiment, the light emitting device 133 comprised of a first white light emitting device, a second white light emitting device, a third white light emitting device and a fourth white light emitting device will be taken as an example. The first white light emitting device, the second white light emitting device, the third white light emitting device and the fourth white light emitting devices are disposed in the form of a linear array in the order listed. The color temperatures of the first and the third white light emitting devices are higher than those of the second and the fourth white light emitting devices. That is, the first and the third white light emitting devices are a cool white light emitting device. The second and the fourth white light emitting devices are a warm white light emitting device. Currents applied to the first and the second white light emitting devices are pulse-width modulated respectively by the first PWM controller 200 and the second PWM controller 300, and currents applied to the third and the fourth white light emitting devices having color temperatures different from those of the first and the second white light emitting devices are controlled respectively by the first controller 400 and the second controller 500 in such a manner that a (x, y) coordinate determined by the mixture of the lights emitted from the first to the fourth white light emitting devices moves onto a black body radiation curve within a 1931 CIE chromaticity diagram.

As such, through the pulse width modulation of the first and the second PWM controllers 200 and 300 and the control of the first and the second controllers 400 and 500, the (x, y) coordinate, which is determined by the mixture of the lights emitted from the first to the fourth white light emitting devices and are located within the 1931 CIE chromaticity diagram, can be moved onto the black body radiation curve within the 1931 CIE chromaticity diagram.

As compared with the first and the second controller 400 and 500, the first PWM controller 200 and the second PWM controller 300 generate momentarily a high pulse. Therefore, the PWM controller is broken many times. Here, even though one of the first and the second PWM controllers 200 and 300 is broken, the currents applied to the cool white light emitting device and the warm white light emitting device can be controlled by the common controller, i.e., the first controller 400 and the second controller 500.

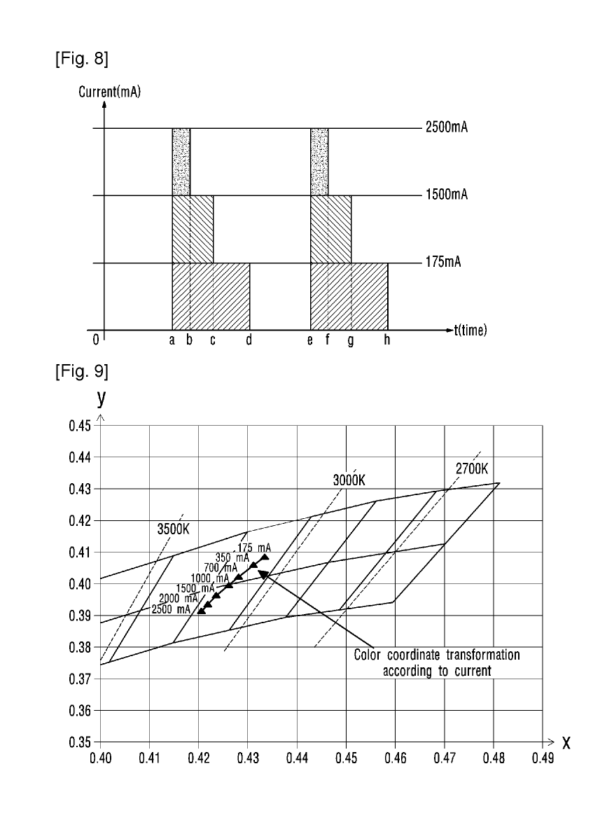

FIG. 8 is a graph showing a current magnitude by the pulse width modulation according to the first embodiment. FIG. 9 is a graph showing a color coordinate change by the pulse width modulation of FIG. 8.

Referring to FIG. 8, it is possible to recognize how the magnitude of the current applied to the white light emitting device is changed according to the lapse of time. Here, a duty cycle is e-a(t).

The magnitudes of the currents applied to the first white light emitting devices can be changed by the pulse width modulation of the first PWM controller. Here, an area representing the magnitude of the current during turn-on time corresponds to the brightness of the white light emitting device. Likewise, the magnitudes of the currents applied to the second white light emitting devices can be changed by the pulse width modulation of the second PWM controller.

When the turn-on time is b-a, the current flowing through the white light emitting device is 2,500 mA. When the turn-on time is c-b, the current flowing through the white light emitting device is 1,500 mA. When the turn-on time is d-c, the current flowing through the white light emitting device is 175 mA.

Here, the magnitudes of the currents flowing during the turn-on time are different from each other in the three cases. However, the brightnesses of the three cases are the same as each other.

With regard to this, FIGS. 8 and 9 show the color coordinates when the current applied to the white light emitting device is 175 mA, 350 mA, 700 mA, 1,000 mA, 1,500 mA, 2,000 mA and 2,500 mA. It can be seen that the more the magnitude of the current is increased, the more (x, y) values on the (x, y) color coordinates is decreased.

In other words, when the pulse width of the current applied to the white light emitting device is modulated and decreased, the magnitude of the current flowing through the white light emitting device is increased. Therefore, the (x, y) color coordinate is located on the bottom left in the graph.

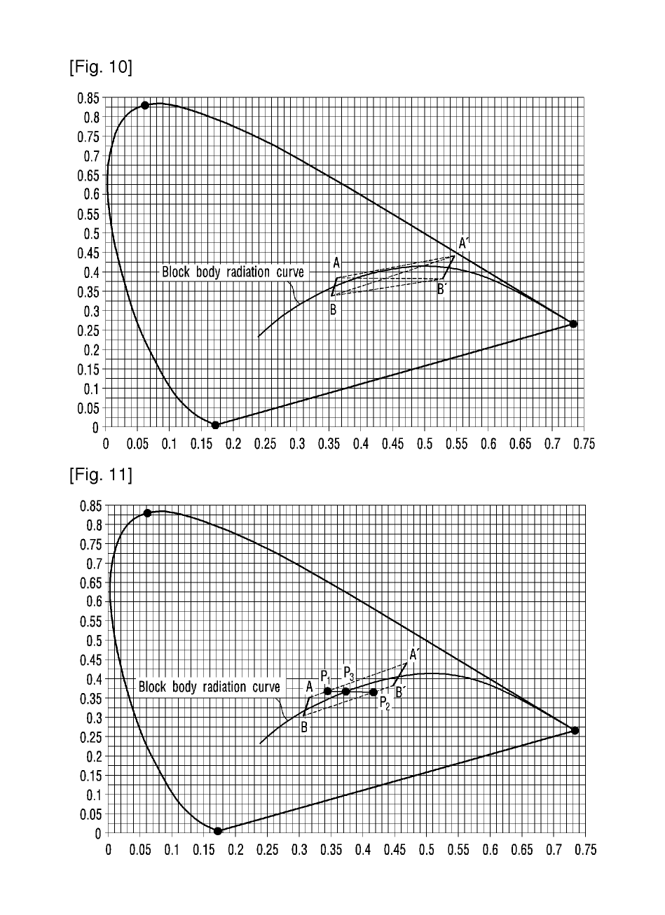

FIG. 10 is a view for describing a lighting control method on the black body radiation curve according to the first embodiment. Here, the first and the second PWM controllers perform a control for the pulse width modulation of the current. The first and the second controllers perform a general control for the current.

Referring to FIG. 10, points A and B represent two end points of a range in which the (x, y) color coordinate of the light emitted by controlling the current applied to the cool white light emitting device (or by controlling the pulse width modulation of the current) is able to move. Points A′ and B′ represent two end points of a range in which the (x, y) color coordinate of the light emitted by controlling the current applied to the warm white light emitting device (or by controlling the pulse width modulation of the current) is able to move. An range in which the (x, y) color coordinate of the light emitted through the pulse width modulation of the current applied to the cool white light emitting device is able to move is located on the bottom left of a range in which the (x, y) color coordinate of the light emitted through the pulse width modulation of the current applied to the warm white light emitting device is able to move.

The first PWM controller performs a pulse width modulation on the current applied to the first white light emitting device. The second PWM controller performs a pulse width modulation on the current applied to the second white light emitting device. Due to the pulse width modulation of the first PWM controller, the cool white light emitting device has the (x, y) color coordinate on a straight line connecting the point A with the point B. Due to the pulse width modulation of the second PWM controller, the warm white light emitting device has the (x, y) color coordinate on a straight line connecting the point A′ with the point B′.

The first controller controls the current applied to the third white light emitting device. The second controller controls the current applied to the fourth white light emitting device. Due to the control of the first controller, the cool white light emitting device has the (x, y) color coordinate on a straight line connecting the point A with the point B. Due to the control of the second controller, the warm white light emitting device has the (x, y) color coordinate on a straight line connecting the point A′ with the point B′.

Here, the (x, y) color coordinate determined by the mixture of the lights emitted from the first to the fourth white light emitting devices may exist on four ranges. That is, the four ranges include 1) a range represented by a straight line connecting the point A with the point A′, 2) a range a range represented by a straight line connecting the point A with the point B′, 3) a range represented by a straight line connecting the point B with the point A′, and 4) a range represented by a straight line connecting the point B with the point B′.

From the above-mentioned principle, the current applied to at least one of the first and the second white light emitting devices is pulse-width modulated and the current applied to at least one of the third and the fourth white light emitting devices is controlled, so that the (x, y) coordinate determined by the mixture of the lights emitted from the first to the fourth white light emitting devices can be moved onto the black body radiation curve within the 1931 CIE chromaticity diagram.

FIG. 11 is a view showing a principle in which a color coordinate is obtained on the black body radiation curve according to the first embodiment. Referring to FIG. 11, the lighting control method according to the first embodiment will be described below.

First, a first set current and a second set current are respectively applied to the first and the second white light emitting devices disposed on the substrate, and then a (x, y) coordinate is obtained, which is determined by the mixture of the lights emitted from the first and the second white light emitting devices and is located within the 1931 CIE chromaticity diagram. Here, the (x, y) coordinate, which is determined by the mixture of the lights emitted from the first and the second white light emitting devices and is located within the 1931 CIE chromaticity diagram, exists, for example, like a point P₁, within a range represented by a straight line connecting the point A and the point A′.

Subsequently, a third set current and a fourth set current are respectively applied to the third and the fourth white light emitting devices which are disposed on the substrate and have color temperatures different from those of the first and the second white light emitting devices, and then a (x, y) coordinate is obtained, which is determined by the mixture of the lights emitted from the first to the fourth white light emitting devices and is located within the 1931 CIE chromaticity diagram. Here, the (x, y) coordinate, which is determined by the mixture of the lights emitted from the third and the fourth white light emitting devices and is located within the 1931 CIE chromaticity diagram, exists, for example, like a point P₂, within a range represented by a straight line connecting the point B and the point B′. A new coordinate is obtained by mixing the obtained (x, y) coordinate which is determined by the mixture of the lights emitted from the first and the second white light emitting devices and is located within the 1931 CIE chromaticity diagram with the (x, y) coordinate, which is determined by the mixture of the lights emitted from the first to the fourth white light emitting devices and is located within the 1931 CIE chromaticity diagram. Here, there is a high probability that the new coordinate is not a point, for example, a point P₃, which is located on the black body radiation curve.

Subsequently, the current applied to at least one of the first and the second white light emitting devices is pulse-width modulated and the current applied to at least one of the third and the fourth white light emitting devices is controlled, and then the (x, y) coordinate determined by the mixture of the lights emitted from the first to the fourth white light emitting devices is moved onto the black body radiation curve within the 1931 CIE chromaticity diagram. Since the obtained the (x, y) coordinate, which is determined by the mixture of the lights emitted from the first to the fourth white light emitting devices and is located within the 1931 CIE chromaticity diagram, is not a point, for example, the point P₃, which is located on the black body radiation curve, the (x, y) coordinate is moved onto a point like the point P₃ on the black body radiation curve by controlling the current. Here, the currents applied to the first to the fourth white light emitting devices are independently controlled, the x value and y value of the (x, y) coordinate become smaller with the decrease of the pulse-width of the current applied to the first white light emitting device or the second white light emitting device.

### Second Embodiment

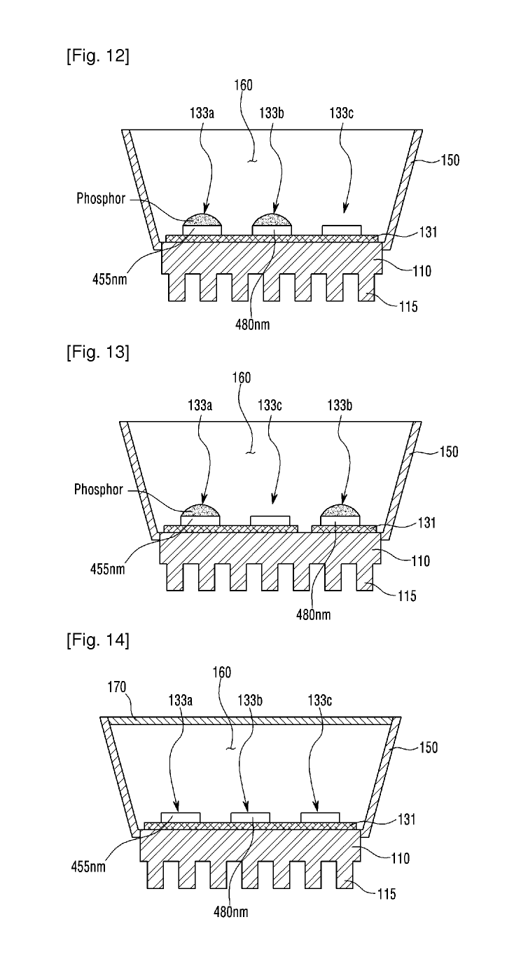

FIG. 12 is a schematic view of a lighting device according to a second embodiment. FIG. 13 is a schematic view of the lighting device including two light sources according to the second embodiment. FIG. 14 is a schematic view of the lighting device including an optical excitation plate according to the second embodiment.

Referring to FIGS. 12 to 13, the lighting device according to the second embodiment may include the heat sink 110, the light source and the reflector 150.

Also, referring to FIG. 14, the lighting device according to the second embodiment may further include the optical excitation plate 170.

Since the configurations of the heat sink 110, the reflector 150 and the optical excitation plate 170 are the same as those of the first embodiment, detailed descriptions thereof will be omitted.

Hereafter, a description of how a light emitting device is disposed will be described in detail with the second embodiment.

### An Embodiment Shown in FIG. 12

Referring to the figure, the lighting device includes a first white light emitting device 133a, a second white light emitting device 133b and a red light emitting device 133c.

The first white light emitting device 133a includes a first blue light emitting chip which is disposed on the substrate 131 and emits first blue light, and a yellow phosphor which emits yellow light in response to the first blue light emitted from the first blue light emitting chip. The yellow phosphor is a garnet (including YAG) phosphor or a silicate phosphor.

The second white light emitting device 133b includes a second blue light emitting chip which is disposed on the substrate 131 and emits second blue light, and a yellow phosphor which emits yellow light in response to the second blue light emitted from the second blue light emitting chip. The first blue light and the second blue light have a wavelength of from 420 nm to 490 nm. The deviation of the wavelength has a range between 1 nm and 70 nm. For example, the wavelengths of the first blue light and the second blue light may be 455 nm and 480 nm respectively. The larger the deviations of the wavelengths of the first blue light and the second blue light become, the smaller the magnitudes of the currents applied to the first and the white light emitting devices 133a and 133b, so that the color of the emitted light is changed. In other words, when the deviations of the wavelengths of the first blue light and the second blue light are relatively large, the magnitude of the current required for changing the color of the emitted light is small. Like the first white light emitting device 133a, the yellow phosphor is a garnet (including YAG) phosphor of a silicate phosphor.

The red light emitting device 133c is disposed on the substrate 131 and includes a red light emitting chip emitting red light.

### An Embodiment Shown in FIG. 13

Referring to the figure, the lighting device includes a first light source and a second light source.

The first light source includes the first white light emitting device 133a and the red light emitting device 133c. The first white light emitting device 133a includes the first blue light emitting chip which is disposed on a first substrate and emits the first blue light, and the yellow phosphor which emits yellow light in response to the first blue light emitted from the first blue light emitting chip. The red light emitting device 133c is disposed on the first substrate and includes a red light emitting chip emitting red light. The yellow phosphor is a garnet (including YAG) phosphor or a silicate phosphor.

The second light source includes the second white light emitting device 133b. The second white light emitting device 133b includes the second blue light emitting chip which is disposed on a second substrate and emits the second blue light, and the yellow phosphor which emits yellow light in response to the second blue light emitted from the second blue light emitting chip. The first blue light and the second blue light have a wavelength of from 420 nm to 490 nm. The deviation of the wavelength has a range between 1 nm and 70 nm. For example, the wavelengths of the first blue light and the second blue light may be 455 nm and 480 nm respectively. The larger the deviations of the wavelengths of the first blue light and the second blue light become, the smaller the magnitudes of the currents applied to the first and the white light emitting devices 133a and 133b, so that the color of the emitted light is changed. In other words, when the deviations of the wavelengths of the first blue light and the second blue light are relatively large, the magnitude of the current required for changing the color of the emitted light is small. Like the first white light emitting device 133a, the yellow phosphor is a garnet (including YAG) phosphor of a silicate phosphor.

While one substrate is used in the first embodiment, the two substrates, i.e., the first and the second substrates are used and the red light emitting device is disposed only on the first substrate in the second embodiment. However, the red light emitting device may be disposed only on the second substrate or may be disposed on both of the first and the second substrates.

### An Embodiment Shown in FIG. 14

Referring to the figure, the lighting device includes a light source and the optical excitation plate 170.

The light source includes a first blue light emitting device 133a emitting the first blue light, a second blue light emitting device 133b emitting the second blue light, and a red light emitting device 133c emitting the red light. The first blue light emitting device 133a, the second blue light emitting device 133b and the red light emitting device 133c are disposed on the substrate 131. The first blue light and the second blue light have a wavelength of from 420 nm to 490 nm. The deviation of the wavelength has a range between 1 nm and 70 nm. For example, the wavelengths of the first blue light and the second blue light may be 455 nm and 480 nm respectively. The larger the deviations of the wavelengths of the first blue light and the second blue light become, the smaller the magnitudes of the currents applied to the first and the blue light emitting devices 133a and 133b, so that the color of the emitted light is changed. In other words, when the deviations of the wavelengths of the first blue light and the second blue light are relatively large, the magnitude of the current required for changing the color of the emitted light is small.

The optical excitation plate 170 is disposed on the light source and is disposed apart at a predetermined interval from the first blue light emitting device 133a, the second blue light emitting device 133b and the red light emitting device 133c. The optical excitation plate 170 includes the yellow phosphor. The yellow phosphor is a garnet (including YAG) phosphor of a silicate phosphor. Unlike the first and the second embodiments, since the first blue light emitting device 133a and the second blue light emitting device 133b are not covered with the yellow phosphor, the optical excitation plate 170 including the yellow phosphor is required to emit the white light.

Here, a lighting design under an optimum condition by means of the light emitting devices 133a, 133b and 133c and the optical excitation plate 170 is the same as that of the above-described first embodiment, a detailed description thereof will be omitted.

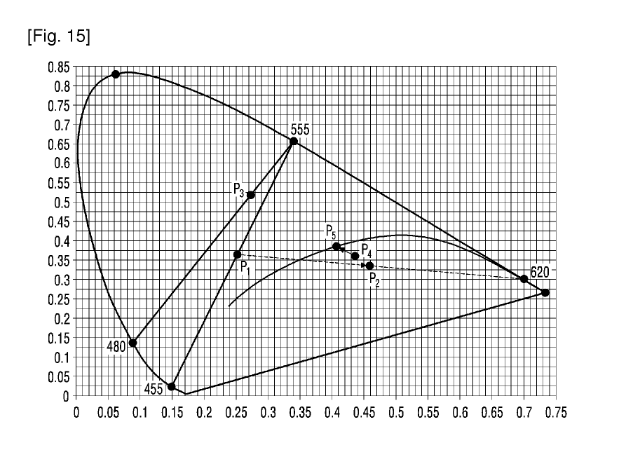

FIG. 15 is a view showing a principle in which a color coordinate is obtained on the black body radiation curve according to the second embodiment, Here, the wavelength of the first blue light emitted from the first blue light emitting chip included in the first white light emitting device (or the first blue light emitting device) is 455 nm. The wavelength of the second blue light emitted from the second blue light emitting chip included in the second white light emitting device (or the second blue light emitting device) is 480 nm. The wavelength of the light that the yellow phosphor included in the first and the second white light emitting devices (or the yellow phosphor of the optical excitation plate) emits in response to the first blue light or the second blue light is 555 nm. The wavelength of the red light emitted from the red light emitting device 620 nm.

Referring to FIGS. 12 and 15, a lighting control method according to the embodiment shown in FIG. 12 will be described below.

First, a first set current is applied to the first white light emitting device 133a disposed on the substrate 131, and then P₁, i.e., (x, y) color coordinate of the light emitted from the first white light emitting device 133a is obtained, which is located within the 1931 CIE chromaticity diagram.

Subsequently, a second set current is applied to the red light emitting device 133c disposed on the substrate 131, and then P₂, i.e., (x, y) color coordinate determined by the mixture of the lights emitted from the first white light emitting device 133a and the red light emitting device 133c is obtained.

Subsequently, a third set current is applied to the second white light emitting device 133b disposed on the substrate 131, and then P₄, i.e., (x, y) color coordinate is obtained, which is determined by the mixture of the lights emitted from the first white light emitting device 133a, the red light emitting device 133c and the second white light emitting device 133b. That is, while P₃, i.e., (x, y) color coordinate of the light emitted from the second white light emitting device 133b is obtained, which is located within the 1931 CIE chromaticity diagram by applying the third set current to the second white light emitting device 133b disposed on the substrate 131, the P₄, i.e., (x, y) color coordinate is obtained by mixing the lights emitted from the first white light emitting device 133a and the red light emitting device 133c.

Subsequently, the current applied to at least one of the first white light emitting device 133a, the second white light emitting device 133b and the red light emitting device 133c is controlled, so that the (x, y) coordinate determined by the mixture of the lights emitted from the first white light emitting device 133a, the red light emitting device 133c and the second white light emitting device 133b is moved onto a point P₅ which is located on the black body radiation curve within the 1931 CIE chromaticity diagram. That is, since the P₄ is not located on the black body radiation curve, the P₄ is moved by the current control to the point P₅ located on the black body radiation curve. Here, the (x, y) coordinate is moved along the black body radiation curve in a direction in which the value of x is reduced. The currents applied to the first white light emitting device 133a, the red light emitting device 133c and the second white light emitting device 133b are independently controlled.

In the lighting control method according to the embodiment shown in FIG. 12, a current control device, for example, the pulse width modulation (PWM) controller, the current controller and the like is used so as to apply and control the current applied to at least one of the first white light emitting device 133a, the second white light emitting device 133b and the red light emitting device 133c. However, there is no limit to this. Any device capable of controlling the current may be used in the lighting control method.

Referring to FIGS. 13 and 15, a lighting control method according to the embodiment shown in FIG. 13 will be described below.

First, the first set current is applied to the first white light emitting device 133a disposed on the first substrate, and then P₁, i.e., (x, y) color coordinate of the light emitted from the first white light emitting device 133a is obtained, which is located within the 1931 CIE chromaticity diagram.

Subsequently, the second set current is applied to the red light emitting device 133c disposed on the first substrate, and then P₂, i.e., (x, y) color coordinate determined by the mixture of the lights emitted from the first white light emitting device 133a and the red light emitting device 133c is obtained.

Subsequently, the third set current is applied to the second white light emitting device 133b disposed on the second substrate, and then P₄, (x, y) color coordinate is obtained, which is determined by the mixture of the lights emitted from the first white light emitting device 133a, the red light emitting device 133c and the second white light emitting device 133b. That is, while P₃, i.e., (x, y) color coordinate of the light emitted from the second white light emitting device 133b is obtained, which is located within the 1931 CIE chromaticity diagram by applying the third set current to the second white light emitting device 133b disposed on the second substrate, the P₄, i.e., (x, y) color coordinate is obtained by mixing the lights emitted from the first white light emitting device 133a and the red light emitting device 133c.

Subsequently, the current applied to at least one of the first white light emitting device 133a, the red light emitting device 133c and the second white light emitting device 133b is controlled, so that the (x, y) coordinate determined by the mixture of the lights emitted from the first white light emitting device 133a, the red light emitting device 133c and the second white light emitting device 133b is moved onto the black body radiation curve within the 1931 CIE chromaticity diagram. That is, since the P₄ is not located on the black body radiation curve, the P₄ is moved by the current control to the point P₅ located on the black body radiation curve. Here, the (x, y) coordinate is moved along the black body radiation curve in a direction in which the value of x is reduced. The currents applied to the first white light emitting device 133a, the red light emitting device 133c and the second white light emitting device 133b are independently controlled.

In the lighting control method according to the embodiment shown in FIG. 13, a current control device, for example, the pulse width modulation (PWM) controller, the current controller and the like is used so as to apply and control the current applied to at least one of the first white light emitting device 133a, the second white light emitting device 133b and the red light emitting device 133c. However, there is no limit to this. Any device capable of controlling the current may be used in the lighting control method.

Referring to FIGS. 14 and 15, a lighting control method according to the embodiment shown in FIG. 14 will be described below.

First, the first set current is applied to the first blue light emitting device 133a disposed on the substrate 131, and then P₁, i.e., (x, y) color coordinate of light formed by a process in which a part of the light emitted from the first blue light emitting device 133a is excited by the yellow phosphor is obtained, which is located within the 1931 CIE chromaticity diagram.

Subsequently, the second set current is applied to the red light emitting device 133c disposed on the substrate 131, and then P₂, i.e., (x, y) color coordinate of light formed by a process in which a part of the lights emitted from the first blue light emitting device 133a and the red light emitting device 133c is excited by the yellow phosphor is obtained.

Subsequently, the third set current is applied to the second blue light emitting device 133b disposed on the substrate 131, and then P₄, i.e., (x, y) color coordinate of light formed by a process in which a part of the lights emitted from the first blue light emitting device 133a, the red light emitting device 133c and the second blue light emitting device 133b is excited by the yellow phosphor is obtained. That is, while P₃, i.e., (x, y) color coordinate of the light emitted from the second white light emitting device 133b is obtained, which is located within the 1931 CIE chromaticity diagram by applying the third set current to the second white light emitting device 133b disposed on the substrate 131, the P₄, i.e., (x, y) color coordinate is obtained by mixing the lights emitted from the first white light emitting device 133a and the red light emitting device 133c.

Subsequently, the current applied to at least one of the first blue light emitting device 133a, the red light emitting device 133c and the second blue light emitting device 133b is controlled, so that the (x, y) coordinate of light formed by a process in which a part of the lights emitted from the first white light emitting device 133a, the red light emitting device 133c and the second blue light emitting device 133b is excited by the yellow phosphor is moved onto the black body radiation curve within the 1931 CIE chromaticity diagram. That is, since the P₄ is not located on the black body radiation curve, the P₄ is moved by the current control to the point P₅ located on the black body radiation curve. Here, the (x, y) coordinate is moved along the black body radiation curve in a direction in which the value of x is reduced. The currents applied to the first blue light emitting device 133a, the red light emitting device 133c and the second blue light emitting device 133b are independently controlled.

In the lighting control method according to the embodiment shown in FIG. 14, a current control device, for example, the pulse width modulation (PWM) controller, the current controller and the like is used so as to apply and control the current applied to at least one of the first blue light emitting device 133a, the second blue light emitting device 133b and the red light emitting device 133c. However, there is no limit to this. Any device capable of controlling the current may be used in the lighting control method.

The present invention is not limited to the embodiment described above and the accompanying drawings. The scope of rights of the present invention is intended to be limited by the appended claims. It will be understood by those skilled in the art that various substitutions, modification and changes in form and details may be made therein without departing from the spirit and scope of the present invention as defined by the appended claims.

1. A lighting device comprising:
a first to a fourth light emitting devices which are disposed on a substrate
a first and a second pulse width modulation controllers which perform a pulse width modulation on currents applied to the first and the second light emitting devices respectively; and
a first and a second controllers which control respectively currents applied to the third and the fourth light emitting devices having color temperatures different from those of the first and the second light emitting devices,
wherein an (x, y) coordinate, which is determined by the mixture of the lights emitted from the first to the fourth light emitting devices and is located within a 1931 CIE chromaticity diagram, is moved onto a black body radiation curve within the 1931 CIE chromaticity diagram through the pulse width modulation of the first and the second pulse width modulation controllers and the control of the first and the second controllers.

2. (canceled)

3. (canceled)

4. The lighting device of claim 1, further comprising a mixing chamber which receives the first to the fourth light emitting devices and has an open upper portion; and an optical excitation plate which is disposed on the mixing chamber and is spaced apart from the first to the fourth light emitting devices.

5. The lighting device of claim 4, wherein a distance between the optical excitation plate and the first to the fourth light emitting devices is determined by an optical orientation angle of each of the light emitting devices and a distance between the light emitting devices.

6. The lighting device of claim 5, wherein, when a distance between the first to the fourth light emitting devices and the optical excitation plate is “H” and the optical orientation angle of each of the light emitting devices is “θ”, the distance G between the light emitting devices is calculated by an equation of G=2H tan(θ/2).

7. The lighting device of claim 4, wherein a distance “L” between an inner wall of the mixing chamber and a light emitting device located at the outermost among the first to the fourth light emitting devices is calculated by an equation of L≧G/2.

8. The lighting device of claim 5, wherein, when a plurality of the light emitting devices are symmetrically disposed, the distance “G” between the light emitting devices is minimized.

9. The lighting device of claim 4, wherein the distance “H” between the first to the fourth light emitting devices and the optical excitation plate is determined within a range in which lights generated from each of the light emitting devices are not superposed on each other or are superposed on each other by less than 10%.

10.-14. (canceled)

15. A lighting device comprising:
a first light emitting device which is disposed on the substrate and emits first light;
a second light emitting device which is disposed on the substrate and emits second light; and
a red light emitting device which is disposed on the substrate and emits red light,
wherein an (x, y) coordinate, which is determined by the mixture of the lights emitted from the first and the second light emitting devices and the red light emitting device and is located within a 1931 CIE chromaticity diagram, is moved onto a black body radiation curve within the 1931 CIE chromaticity diagram by wavelength deviations of 1 nm to 70 nm of the first and the second lights.

16. (canceled)

17. (canceled)

18. The lighting device of claim 15, wherein the larger the deviations of the wavelengths of the first and the second lights become, the smaller the magnitudes of currents applied to the first and the second white light emitting devices, so that a color of the emitted light is changed.

19. (canceled)

20. The lighting device of claim 15, wherein the substrate comprises a first substrate and a second substrate disposed apart from the first substrate, wherein the first light emitting device is disposed on the first substrate, wherein the second light emitting device is disposed on the second substrate.

21. The lighting device of claim 40, wherein a distance between the optical excitation plate and each of the light emitting devices is determined by an optical orientation angle of each of the light emitting devices and a distance between the light emitting devices.

22. The lighting device of claim 21, wherein, when a distance between the first and the second light emitting devices and the red light emitting device and the optical excitation plate is “H” and the optical orientation angle of each of the light emitting devices is “θ”, the distance G between the light emitting devices is calculated by an equation of G=2H tan(θ/2).

23. (canceled)

24. The lighting device of claim 21, wherein a distance “L” between an inner wall of the mixing chamber and a light emitting device located at the outermost among the light emitting devices is calculated by an equation of L≧G/2.

25. The lighting device of claim 21, wherein, when a plurality of the light emitting devices are symmetrically disposed, the distance “G” between the light emitting devices is minimized.

26. The lighting device of claim 15, wherein the distance “H” between each of the light emitting devices of the light source and the optical excitation plate is determined within a range in which lights generated from each of the light emitting devices are not superposed on each other or are superposed on each other by less than 10%.

27.-31. (canceled)

32. A lighting control method comprising:
a first step of applying first set current and second set current to a first and a second light emitting devices respectively, and of obtaining a (x, y) coordinate which is determined by the mixture of the lights emitted from the first and the second light emitting devices and is located within a 1931 CIE chromaticity diagram
a second step of respectively applying third set current and fourth set current to a third and a fourth light emitting devices having color temperatures different from those of the first and the second light emitting devices, and of obtaining a (x, y) coordinate which is determined by the mixture of the lights emitted from the first to the fourth light emitting devices and is located within the 1931 CIE chromaticity diagram and
a third step of pulse-width modulating the current applied to at least one of the first and the second light emitting devices, of controlling the current applied to at least one of the third and the fourth light emitting devices, and of moving the (x, y) coordinate determined by the mixture of the lights emitted from the first to the fourth light emitting devices onto a black body radiation curve within the 1931 CIE chromaticity diagram.

33. (canceled)

34. The lighting control method of claim 32, wherein, in the third step, an x value and a y value of the (x, y) coordinate become smaller with the decrease of a pulse-width of the current applied to the first light emitting device or the second light emitting device.

35. A lighting control method comprising:
a first step of applying first set current to a first light emitting device, and of obtaining a (x, y) coordinate which is determined by light emitted from the first light emitting device and is located within a 1931 CIE chromaticity diagram
a second step of applying second set current to a red light emitting device, and of obtaining a (x, y) coordinate which is determined by the mixture of the lights emitted from the first light emitting device and the red light emitting device;
a third step of applying third set current to a second light emitting device, and of obtaining a (x, y) coordinate which is determined by the mixture of the lights emitted from the first light emitting device, the red light emitting device and the second light emitting device; and
a fourth step of controlling the current applied to at least one of the first light emitting device, the second light emitting device and the red light emitting device, and of moving the (x, y) coordinate determined by the mixture of the lights emitted from the first light emitting device, the red light emitting device and the second light emitting device onto a black body radiation curve within the 1931 CIE chromaticity diagram.

36. The lighting control method of claim 35, wherein the first light emitting device and the second light emitting device use a light emitting chip emitting blue light and light excited by phosphor emitting light having a wavelength different from that of the blue light in response to the blue light, so that the color coordinate is obtained.

37. The lighting control method of claim 35, wherein, in the fourth step, the current applied to at least one of the first light emitting device, the second light emitting device and the red light emitting device is controlled, and then the (x, y) coordinate moves along the black body radiation curve in a direction in which the value of x is reduced.

38. (canceled)

39. (canceled)

40. The lighting device of claim 15, further comprising a mixing chamber which receives the first and the second light emitting devices and the red light emitting device and has an open upper portion; and an optical excitation plate which is disposed on the mixing chamber and is spaced apart from the first and the second light emitting devices and the red light emitting device.
